(19) United States
(12) Patent Application Publication
(10) Pub. No.: US 2004/0230003 A1
(43) Pub. Date: Nov. 18, 2004

(54) Transparent rubber-modified monovinylidene aromatic resin

(76) Inventors: Ray-Hsi Hsu, Taichung (TW); Chen Hsiang Fang, Taichung (TW)

Correspondence Address: Hsu, Ray-Hsi, P. O. BOX 55-124, TAICHUNG, TW

(21) Appl. No.: 10/793,765

(22) Filed: Mar. 8, 2004

(30) Foreign Application Priority Data
May 15, 2003 (JP) JP2003-137496

(51) Int. Cl. C08L 33/06

(52) U.S. Cl. 525/227

(57) ABSTRACT

The present invention discloses a transparent rubber-modified monovinylidene aromatic resin. The rubber-modified monovinylidene aromatic resin comprises: a dispersed rubber particle (A) and a continuous phase matrix copolymer (B). The surface of the molding has a maximum height difference (ΔHmax) of less than 3,200 Å, and an average height difference (ΔHave) of less than 2,000 Å when measured with a surface profiler. The average ratios of major diameter to minor diameter of said rubber particles before and after annealing at 120° C. for 40 mins are A1 and A2 respectively, and the ratio of A1/A2 ranges form 1.08 to 2.35.

### BACKGROUND OF THE INVENTION

1. Field of the Invention

The present invention relates to a transparent rubber-modified monovinylidene aromatic resin and, particularly to a resin comprising a continuous phase matrix copolymer copolymer (B) and a disperse rubber particle (A), which exhibit good practical transparency and physical properties.

2. Description of Related Arts

Rubber-modified monovinylidene aromatic resin has been employed widely as moldings for engineering and like applications, such as parts or components for electric applications, electronic equipments, automotive vehicles and the like, for their excellent mechanical strength and processability and the like.

Generally, rubber-modified monovinylidene aromatic resin is opaque, and thus usage thereof is limited. For conventional technique to improve mechanical strength and transparency of the resin thereof, styrene-butadiene block copolymers are provided to blend with the polystyrenic resin. However, it cannot achieve a good balance of mechanical strength and transparency of the resin by such method.

Theoretically, good transparency of rubber-modified monovinylidene aromatic resin means its molding product having a good transparency by observing in a viewing angle of 90 degrees with respect to the molding surface. However, it usually becomes less transparent while observing the molding in an incline angle with respect to the molding surface. That is, the practical transparency of rubber-modified monovinylidene aromatic resin becomes another problem and thus reduces the overall quality of the resin.

Japanese Patent Publication No. 180907/1992 discloses a method for improving transparency and mechanical strength of the resin by copolymerizing styrene and methyl methacrylate in existence of styrene-butadiene copolymers. However, it is still insufficient to satisfy the property of practical transparency.

It has now surprisingly been found that various problems of the above resin can be overcome by providing a transparent rubber-modified monovinylidene aromatic resin comprising (i) 1-25 wt. % of dispersed rubber particle (A) comprising rubbery copolymer (ii) 99-75 wt. % of continuous phase matrix copolymer copolymer (B); wherein said copolymer (B) is prepared form monomers comprising 20-70 parts by weight of monovinylidene aromatic monomers, 30-80 parts by weight of ester of (meth)acrylic acid monomers and 0-40 parts by weight of copolymerizable monomers.

### SUMMARY OF THE INVENTION

The object of the present invention is to provide a transparent rubber-modified monovinylidene aromatic resin, which exhibits good practical transparency and excellent impact strength.

Accordingly, the transparent rubber-modified monovinylidene aromatic resin comprises (i) 1-25 wt. % of dispersed rubber particle (A) comprising rubbery copolymer (ii) 99-75 wt. % of continuous phase matrix copolymer (B); wherein said copolymer (B) is prepared from monomers comprising 20-70 parts by weight of monovinylidene aromatic monomers, 30-80 parts by weight of ester of (meth)acrylic acid monomers and 0-40 parts by weight of copolymerizable monomers; and

wherein the maximum height difference (ΔHmax) of the surface of the molding of said transparent rubber-modified monovinylidene aromatic resin is less than 3,200 Å and the average height difference (ΔHave)is less than 2,000 Å; wherein said molding is produced by injection with a mirror mold; wherein the ratio of A1/A2 of the rubber particles of dispersed rubber particle (A) having a major diameter of greater than 0.3 μm and located at a depth of 1.8-2.2 μm from a surface of said molding is in the ranges of 1.08˜2.35; wherein A1 and A2 represent the average ratio of major diameter to minor diameter of said rubber particles before and after annealing at 120° C. for 40 mins of said molding, respectively.

According to the above composition, the transparent rubber-modified monovinylidene aromatic resin with good practical transparency and excellent mechanical strength can be obtained.

The dispersed rubber particle (A) is dispersed in the continuous phase matrix copolymer (B). The rubber particles of the dispersed rubber particle (A) are discrete rubber particles having grafted thereon and/or occluded therein a rigid copolymer comprising the continuous phase matrix copolymer (B).

The rubbery copolymer used in the present invention includes a block copolymer prepared by anionic polymerization, in which monovinylidene aromatic monomers and diene monomers are polymerized in the presence of an organolithium compounds, and an organic solvent. The rubbery copolymer has a Moony viscosity (ML₁₊₄) from 20 to 80, and a solution viscosity of 3˜60 cps (25° C., 5 wt. % of rubbery copolymers in styrene). The rubbery copolymer contains more than 8 wt. % of 1,2-vinyl structure of the dienic unit. The rubbery copolymer can be a homopolymer block structure, a random copolymer block structure, or a tapered block structure. The rubbery copolymer can be a linear or branch structure.

In addition to the above block copolymers, the rubbery copolymers of the present invention also can be used together with less than 20 wt. % of butadiene homopolymers or random styrene-butadiene copolymer.

The rubbery copolymers are well known and disclosed in U.S. Pat. Nos. 2,975,160, 3,094,514, 3,135,716, 3,244,664, and 3,318,862, Japanese Patent Nos. 875/1973, 46691/1973, and 36957/1974, and Japanese Patent Publication Nos. 40734/1980, and 40513/1982.

In addition, it is better to use the rubbery copolymer in admixture of the aforementioned rubbery copolymer and styrene-butadiene copolymers having content of 1,2-vinyl structure of 20˜50 wt %, so that the transparent rubber-modified monovinylidene aromatic resin can exhibit better practical transparency and excellent impact strength.

Examples of the monovinylidene aromatic monomers of the rubbery copolymers can be styrene, α-methylstyrene, p-methylstyrene, m-methylstyrene, o-methylstyrene, ethylstyrene, 2,4-dimethylstyrene, p-tert-butylstyrene, p-α-methylstyrene, bromostyrene, dibromostyrene, 2,4,6-tribromostyrene, etc., or mixtures thereof.

Examples of the diene monomers can be 1,3-butadiene, 2-methyl-1,3-butadiene, 2,3-dimethyl- 1,3-butadiene, 1,3-pentadiene, 1,3-hexadiene, etc., or mixtures thereof, wherein 1,3-butadiene and 2-methyl-1,3-butadiene are preferred.

Examples of the organo lithium compound used in the rubbery copolymers contain more than one lithium atom, for example, ethyllithium, n-pentyllithium, iso-propyllithium, n-butyllithium, sec-butyllithium, hexyllithium, cyclo-hexyllithium, phenyllithium, benzyllithium, naphthlithium, tert-butyllithium, tri-methylene dilithium, tetra-methylene dilithium, butadiene dilithium, iso-pentadiene dilithium, etc., or mixtures thereof.

During polymerization of the rubbery copolymer, the rate of polymerization, content of 1,2-vinyl structure of the rubbery copolymer and random structure of diene monomers and styrenic monomers can be adjusted with a polar compound or a randomizer selected from ethers, amines, thio-ether, alkyl benzene, sulfonate salt, potassium alkyl oxide and sodium alkyl salt.

The amount of the rubbery copolymer contained in the transparent rubber-modified monovinylidene aromatic resin composition of the present invention is 1˜25 wt. %, preferably 8-25 wt. %, more preferably 12-25 wt. %. Impact strength of the resin product can be improved when the amount of the rubbery copolymers is more than 1 wt. %. Transparency and molding processing of the resin product can be promoted when the amount of the rubbery copolymers is less than 25 wt. %.

The continuous phase matrix copolymer copolymer (B) is prepared from monomers comprising 20-70 parts by weight of monovinylidene aromatic monomers, 30-80 parts by weight of ester of (meth)acrylic acid monomers, and 0-40 parts by weight of copolymerizable monomers. Examples of the monovinylidene aromatic monomers can be those monovinylidene aromatic monomers aforementioned in the rubber copolymers.

Examples of the ester of (meth)acrylic acid monomers can be ester of methacrylic acid and ester of acrylic acid monomers. The ester of methacrylic acid monomers include methyl methacrylate, ethyl methacrylate, butyl methacrylate, phenyl methacrylate, cyclohexyl methacrylate, 2-hydroxyl ethyl methacrylate, glycidyl methacrylate, etc. The ester of acrylic acid monomers include methyl acrylate, ethyl acrylate, n-butyl acrylate, 2-methyl pentyl acrylate, 2-ethyl pentyl acrylate, octyl acrylate. Among these, C1˜C4 alkyl acrylate and methacrylate are preferred, more preferably methyl methacrylate and n-butyl acrylate.

The copolymerizable monomers of copolymer (B) are not particularly limited and can be provided in an appropriate amount only if the desired transparency of the final resin is achieved.

Examples of the copolymerizable monomers can be an unsaturated fatty acid such as itaconic acid, maleic acid, fumaric acid, butenoic acid, cinnamic acid, acrylic acid, methacrylic acid; a vinyl cyanide monomer such as acrylonitrile, methacrylonitrile; or an unsaturated carboxylic anhydrides such as maleic anhydride, itaconic anhydride, citraconic anhydride; the maleimide monomers can be N-methyl maleimide, N-methyl maleimide, N-iso-propyl maleimide, N-butyl maleimide, N-hexyl maleimide, N-octyl maleimide, N-dodecyl maleimide, N-cyclohexyl maleimide, N-phenyl maleimide, N-2,3-xylyl maleimide, N-2,4-xylyl maleimide, N-2,3- diethylbenzyl maleimide, N-2,4-diethylbenzyl maleimide, N-2,3-dibutylbenzyl maleimide, N-2,4-dibutylbenzyl maleimide, N-2,6-xylyl maleimide, N-2,3-dichlorobenzyl maleimide, N-2,4-dichlorobenzyl maleimide, N-2,3-dibromobenzyl maleimide, N-2,4-dibromobenzyl maleimide, etc.; wherein N-phenyl maleimide is preferred.

The continuous phase matrix copolymer (B) can be either a linear or branch structure, wherein the branch structure may reach better balance between impact strength and processing properties. The continuous phase matrix copolymer (B) can be prepared by adding one or more species of unsaturated multi-functional monomers, multi-functional initiators, multi-functional chain-transfer agents during polymerization.

The weight average molecular weight of the continuous phase matrix copolymer (B) is not particularly limited, generally from 50,000 to 300,000, preferably from 60,000 to 200,000, and more preferably from 70,000 to 150,000. The amount of the continuous phase matrix copolymer (B) is generally from 99 to 75 wt. %, preferably from 92 to 75 wt. %, and more preferably from 88 to 75 wt. %, based on transparent-rubber-modified monovinylidene aromatic resin of present invention. Moreover, the dispersed rubber particle (A) has a weight average diameter ranging from 0.18 to 1 μm, preferably from 0.2 to 0.6 μm, and more preferably from 0.23 to 0.5 μm. The amount of the dispersed rubber particle (A) having diameter greater than 0.78 μm is generally from 0 to 25 wt. %, preferably from 0 to 17 wt. %, and more preferably from 1 to 15 wt. %, based on total the dispersed rubber particle (A), When the amount of the dispersed rubber particle (A) having diameter greater than 0.781 μm is in the range mentioned above, the resin exhibits better practical transparency, transparency and impact strength.

The weight average diameter of the dispersed rubber particle (A) and the amount of those with diameter greater than 0.781 μm are determined with a TEM (Transmission Electronic Microscope) by using ultrathin section of the resin. The following equation is used to evaluate the weight average diameter of the dispersed rubber particle (A):

$$\begin{matrix}Weight average \\ diameter\end{matrix} = \frac{Σ ni {Di}^{4}}{Σ ni {Di}^{3}}$$

wherein ni is the number of rubber particles having diameter Di.

In the present invention, the gel content (insoluble parts of the resin) is not particularly limited, and is generally in the range of 2 to 40 wt. %, preferably in the range of 8 to 35 wt. %, and more preferably in the range of 12 to 30 wt. %. In addition, the swelling index of the resin is not particularly limited and is generally in the range of 2 to 25, preferably in the range of 3 to 20, and more preferably in the range of 5 to 15.

The gel content and the swelling index of the resin are measured by dissolving 1 gram of resin in a mixture solution of toluene and acetone (in a volume ratio of 1:1) at a temperature of 25° C. for 24 hours, then the solution is centrifuged at 15,000 rpm for 20 mins to separate into two phase. The swollen insoluble components in the lower part can be removed and is vacuum dried at 80° C. for 12 hours to get the insoluble gel in dried form. The gel content of the resin is evaluated with the following equation:

$$Gel content ( wt . \% ) = \frac{\begin{matrix}weight of insoluble gel \\ in dried form\end{matrix}}{weight of the resin} \times 100 \%$$

The Swelling Index of the resin is evaluated with the following equation:

$$\begin{matrix}Swelling \\ Index\end{matrix} = \frac{weight of the swollen insoluble components}{weight of the insoluble gel in dried form}$$

To measure the maximum height difference (ΔHmax) and the average height difference (ΔHave) of the rubber modified monovinylidene aromatic resin of the present invention, a mirror mold is provided for injection molding of the resin to obtain a sample molding of 3 mm in thickness and 55 mm in diameter. The mirror mold is according to Akume No.2 standard (referring Japanese “Plastic Mold Hand Book”, Chap. 4, Sec. 4.8.2 (2) Polishing Criteria for Injection Mold; 1989) and has a surface roughness of about 0.1 μm measured by JIS B0601, Ra method. During injection molding, the cylinder temperature is generally from 180° C. to 300° C., preferably from 200° C. to 280° C.; and the mold temperature is generally from 20° C. to 100° C., preferably from 40° C. to 90° C. Flat area of the surface of the sample molding is then measured with a surface profiler to obtain different values of heights (H) within a region of 1,000 μm for each measurement and the maximum height (Hmax) and the minimum height (Hmin) of the measurement are determined to obtain a height difference ΔHi (=Hmax−Hmin). After repeating the measurement twenty times at different locations, an average height difference (ΔHave) is obtained (average value of 20 ΔHi).

The maximum ΔHi among the above 20 times of measurements is defined as maximum height difference (ΔHmax). In the present invention, ΔHmax is less than 3,200 Å, preferably less than 3,000 Å, more preferably less than 2,800 Å, and ΔHave is less than 2,000 Å, preferably less than 1,900 Å, more preferably less than 1,800 Å. The practical transparency of the resin is good when it satisfies the above conditions of ΔHmax and ΔHave.

The sample molding of the resin is also measured with an electronic microscope. A photograph of the above measurement is obtained, which is located at a depth of 1.8-2.2 μm from a surface of said molding. The rubber particles of the dispersed rubber particle (A) having a major diameter of greater than 0.3 μm of said photograph is analyzed to obtain the ratio of A1/A2. A1 and A2 represent the average ratio of major diameter to minor diameter of said rubber particles major diameter of greater than 0.31 μm and located at a depth of 1.8-2.2 μm from a surface of said molding before and after annealing at 120° C. for 40 mins, respectively. In the present invention, the ratio of A1/A2 is in the range of 1.08˜2.35, preferably in the range of 1.08˜2.2, more preferably in the range of 1.1˜2.0.

The practical transparency and impact strength of the resin is good when the ratio of A1/A2 is in the range of 1.08˜2.35.

In the present invention, the method for producing the resin is not particularly limited, preferably by bulk or solution polymerization. Such methods may obtain better transparency and be advantageous to molding process, for example, higher heat stability of the resin and less contamination to molds.

The process for production of the rubber-modified monovinylidene aromatic resin is performed by polymerizing the monovinylidene aromatic monomers, eater of (meth)acrylic acid monomers and optionally copolymerizable monomers with presence of the rubbery copolymer. The polymerization can be carried out in a batch or continuous process with bulk or solution polymerization, wherein the continuous process is preferred as the product thereof exhibits better transparency and impact strength. In the case of continuous solution polymerization, a mixture including the above rubbery copolymer, monomers and optionally solvents to form a solution of raw material mixtures, which is dissolved within a dissolving tank having high shear and high stirring rate. The dissolving tank is usually installed with screw-type agitator or other types of agitators, and is able to completely dissolve the rubbery copolymer as a rubber solution, so as to be easily pumped into reactors. The rubber solution is then continuously fed into a first reactor and/or a second reactor, and/or the following reactors. Optionally, the chain transfer agent and the initiator may be added therein.

The aforementioned reactors can be one or more types of a continuous stirring tank reactor (CSTR), a plug flow reactor (PFR) or a static mixer type reactor. The reaction temperature is controlled at 70° C.˜230° C.

For polymerization reaction of the present invention, the first reactor is preferably a CSTR, and connected to the second and/or the following reactors. The following reactors can be a CSTR, a PFR, a static mixer type reactor, or other suitable reactor. To obtain product having better practical transparency, the first reactor is preferably a CSTR and the last reactor is a PFR; more preferably the first to the third reactors are CSTRs and the fourth reactor is a PFR.

In general, conversion of monomers in the first reactor is approximately from 1 to 40 wt. %, preferably from 2 to 35 wt. %, and more preferably from 3 to 30 wt. %. The conversion of monomers of polymerization at the first reactor is determined in accordance with the kind, amount and viscosity of the rubbery copolymer. In order to obtain better practical transparency of the resin, the final conversion of the monomers in the present invention is generally from 60 to 98%, preferably from 70 to 98%, and more preferably from 82 to 97%.

In the present invention, the solvent used in polymerization can be aromatic hydrocarbons, ketones, and esters, wherein the preferred examples of aromatic hydrocarbons are toluene, ethylbenzene and xylene, the preferred examples of ketone is butanone, and the preferred examples of esters is ethyl acetate. Additionally, aliphatic hydrocarbons such as n-hexane, cyclohexane, n-heptane, etc., could be used as the solvent in the present invention.

The initiator used for producing the transparent rubber-modified monovinylidene aromatic resin is in an amount of 0-2 parts by weight per 100 parts of monomers, preferably 0.001-0.7 part by weight, based on 100 parts of monomers. Examples of the initiator can be of the following types:

(I) Alkyl peroxide: t-butyl cumyl peroxide (abbreviated as Per butyl C), α,α′-bis-(t-butyl peroxy)diisopropyl benzene (abbreviated as Per butyl P), and 1,3-bis-(t-butyl peroxy) diisopropyl benzene (abbreviated as PX-14).

(II) Peroxyester: di-t-butyl-peroxy-hexahydro-terephthalate (abbreviated as BPHTP).

(III) Peroxycarbonate: di-ethylene glycol-bis(t-butyl-peroxycarbonate, (Kayaku Akzo company product KAYAREN O-50, etc.

(IV) Diacyl peroxide: m-toluoyl and benzoyl peroxide (abbreviated as Nyper BMT-K40).

(V) Peroxy ketals: 4,4′-di-t-butyl peroxy valeric acid-n-butyl ester (abbreviated as TX-17).

To obtain the resin with good practical transparency, the initiator for polymerization is usually used in admixture of two or more types of the above types (I)˜(V), preferably three or more types of types (I)˜(V), and more preferably in admixture of types (I), (II) and (IV).

The chain transfer agent used in the present invention is usually added in an amount of 0-2 parts by weight, preferably 0.01-0.7 part by weight, based on 100 parts of monomers. The suitable examples include methyl mercaptan, n-butyl mercaptan, cyclohexyl mercaptan, n-dodeyl mercaptan, stearyl mercaptan, t-dodeyl mercaptan (TDM), n-propyl mercaptan, n-octyl mercaptan, t-octyl mercaptan, monoethylamine, dimethylamine, triethylamine, isopropylamine, diisopropylamine, butylamine, and di-n-butylamine. Other chain transfer agents such as pentaphenylethane, α-methyl styrene dimmer and terpinolene can also be used.

During polymerization of the transparent rubber-modified monovinylidene aromatic resin, the multifunctional unsaturated monomers can be added in an amount of 0-1 parts by weight, preferably 0.005-0.6 part by weight, based on 100 parts of monomers. Examples of the multifunctional unsaturated monomers are as follows:

(I) Vinyl benzene monomers: divinyl benzene, 1,2,4-trivinyl benzene, and 1,3,5-trivinyl benzene, etc.

(II) Dimethacrylate monomers: ethylene glycol dimethacrylate, di ethylene glycol dimethacrylate, tri-ethylene glycol dimethacrylate, polyethylene glycol dimethacrylate, 1,3-propylene glycol dimethacrylate, 1,4-butylene glycol dimethacrylate, 1,6-hexanene glycol dimethacrylate, neo pentyl glycol dimethacrylate (abbreviated as PGDMA), dipropylene glycol dimethacrylate, polypropylene glycol dimethacrylate, 2,2-bis-(4-methacryloxy diethoxy phenyl) propane, etc.

(III) Trimethacrylate monomers: trimethylol propane trimethacrylate, triethylol ethane trimethacrylate, etc.

(IV) Diacrylate monomers: ethylene glycol diacrylate, diethylene glycol diacrylate, tri ethylene glycol diacrylate, polyethylene glycol diacrylate, 1,3-di-propylene glycol diacrylate, 1,4-di-butylene glycol diacrylate, 1,6-hexylene glycol diacrylate, neopentyl glycol diacrylate (abbreviated as PGDA), di-propylene glycol diacrylate, polypropylene glycol diacrylate, 2,2-bis(4-acryloxy propoxy phenyl)propane, 2,2-bis(4-acryloxy di ethoxy phenyl) propane, etc.

(V) Triacrylate monomers: trimethylol propane triacrylate, triethylol ethane triacrylate, etc.

(VI) Tetraacrylate monomers: tetramethylol methane tetraacrylate, etc.

After the polymerization is completed, the resulting copolymer solution is removed from the reactors, and is devolatilized passes through the preheater and the devolatilizing device for removing the unreacted monomers and solvents to produce the transparent rubber-modified monovinylidene aromatic resin of the present invention.

The preheater is usually controlled at 200° C.˜280° C., preferably 245° C.˜270° C. so as to obtain product having good practical transparency and color. The devolatilizing device can be a devolatilizer and/or single-screw or twin-screw extruder with a vent. In addition, stripping agents such as water, cyclohexane, carbon dioxide, etc., can be added into the extruder in an amount of 10 wt. % per 100 parts of extrusion feeding. The extruder may include a kneading zone, a pumping zone, etc. The screw of the extruder is operated at 120-350 rpm, and temperature of the extruder is about 160° C.˜300° C., preferably 240° C.˜260° C., so as to obtain product having good practical transparency and color. In the present invention, a twin-screw extruder with a vent for removing volatile components is preferred. Furthermore, the devolatilizer may include a vacuum unit and be used singly or a plurality of devolatilizer in series. The devolatilizer is usually operated at 180° C.˜320° C., preferably at 200° C.˜300° C., and more preferably at 235° C.˜260° C., so as to obtain product having good practical transparency and color. The pressure (absolute pressure) of the devolatilizer is usually controlled below 300 Torr, preferably 200 Torr, and more preferably 100 Torr. Other devolatilizing device such as a thin film evaporator can also be applied.

After devolatilizing, the content of volatile components, such as residual monomers, solvents, etc., is reduced to less than 1 wt. %, preferably 0.8 wt. %, and more preferably 0.25 wt. %, so as to obtain product having good practical transparency and color.

Furthermore, after the resin has passed through the devolatilizing device, it can be extruded again. Additives such as antioxidant, lubricant can be optionally added, particularly t-amyl peroxide in an amount of 0-0.5 wt. %, preferably 0.001-0.2 wt. %, based on 100 wt. % of the resin, so as to obtain product having good practical transparency and color. The t-amyl peroxides aforementioned can be di-t-amyl peroxide, 1,1 -di-(t-amyl peroxy)-cyclohexane, 2,2-di-(t-amyl peroxy)propane, ethylene-3,3-di-(t-amyl peroxy) butyrate, etc., wherein di-t-amyl peroxide is preferred.

In the present invention, practical transparency and impact strength of the transparent rubber-modified monovinylidene aromatic resin can be improved by applying at least two of the following conditions(items):

(A) Using at least two types of the polymerization initiators, such as alkyl peroxide, peroxyester, peroxycarbonate, diacyl peroxide and peroxy ketals.

(B) Selecting specific reactors and arrangement thereof and setting the final conversion for polymerization; for example, three to six CSTRs connected in series, preferably the first reactor being CSTR and the last reactor being PFR, and more preferably three CSTRs arranged as the first to the third reactors and a PFR arranged as the last reactor; and the final conversion generally being 60-98%, preferably 70-98%, and more preferably 82-97%.

(C) Extruding the resin again after passing through the devolatilizing device, and particularly adding the t-amyl peroxide therein.

(D) Controlling operation conditions of the devolatilizing device and contents of the residual volatile components:

(D₁) Temperature of the pre-heater: 200° C.˜280° C., preferably 245° C.˜270° C.;

(D₂) Temperature of the devolatilizer: 180° C.˜320° C., preferably 235° C.˜260° C.

(D₃) Temperature of the extruder: 160° C.˜300° C., preferably 240° C.˜260° C.; pressure of the vent: below 300 Torr, and preferably adding a stripping agent such as water, in an amount below 10 wt. %; and

(D₄) Content of the residual volatile components in the resin: less than 1 wt. %, preferably less than 0.25 wt. %.

(E) Selecting specific rubbery copolymers, for example, low-viscosity styrene-butadiene block copolymers, random styrene-butadiene copolymers, and particularly styrene-butadiene copolymers having high content of 1,2-vinyl structures (for example, at least 25%, preferably 28%), or mixtures thereof.

In the present invention, a combination of at least three items of the above (A), (B), (C), (D) and (E) can be applied; to obtain product having good practical transparency, preferably combination of four or more items thereof is applied, more preferably the combination of (A), (C) and (D), or (A), (B), (D) and (E) is applied.

Without substantially adversely affecting the properties, such as practical transparency, transparency and impact strength, of the rubber-modified monovinylidene aromatic resin of the present invention, other additives such as coloring agents , fillers, flame retardants, flame retarding aids (antimony trioxide, etc.), light stabilizers, thermal stabilizers, plasticizers, lubricants, release agent, stickening agent, anti-statics agent, antioxidants, electrical conducting agents, etc., can be optionally added. The additives can be mineral oil such as ester-based plasticizers including butyl stearate, polyester type plasticizers, poly-organosiloxanes including polydimethyl siloxane, fatty acid and their metal salts thereof, hindered amine-based antioxidant, glass fiber, etc., which can be used alone or in combination with one another, and added during or after polymerization.

The ester-based plasticizer or mineral oil are usually added in an amount of 0-5 wt. %, preferably 0.05-2 wt. %; and the poly-organosiloxane is added in an amount of 0-0.5 wt. %, preferably 0.002-0.2 wt. %, based on the weight of the resin.

Furthermore, without substantially reducing transparency of the resin of the present invention, other resins can be added, for example, styrene-alkyl(meth)acrylate-acrylonitrile copolymer, styrene-alkyl(meth)acrylate copolymer, styrene-alkyl(meth)acrylate-acrylonitrile-maleimide copolymer, styrene-alkyl(meth)acrylate-maleimide copolymer, alkyl(meth)acrylate-maleimide copolymer, or the above copolymers modified with diene rubber, for example, styrene-diene-alkyl (meth)acrylate-acrylonitrile copolymer, styrene-diene-alkyl(meth)acrylate copolymer, styrene-diene-alkyl (meth)acrylate-acrylonitrile-maleimide copolymer, styrene-diene-alkyl(meth)acrylate-maleimide copolymer, alkyl(meth)acrylate-diene-maleimide copolymer, etc.

The above resin can be added in an amount of 0-200 parts by weight per 100 parts of transparent-rubber-modified monovinylidene aromatic resin, so that heat resistance, rigidity and molding processability of the resin can be enhanced.

The application for processing of the transparent-rubber-modified monovinylidene aromatic resin of the present invention is not particularly limited and can be applied to product formed by injection molding, compression molding, extrusion molding, blow molding, thermoforming, vacuum-forming, for example, sheets, films, etc. The product can be sheets, films, moldings, etc. The recipes can also be adjusted to promote processability, heat resistance, etc.

The resin additives and other components aforementioned can be mixed in a Brabender, a Banbury mixer, a roll kneader, a single-screw or twin-screw extruder. The extruded product is then cooled and pelletized. The mixing process is usually performed at 160° C.˜280° C., preferably 180° C.˜250° C., and the addition step of the components does not particularly limited.

Test of Physical Properties

1. Transparency and Practical Transparency (Haze):

Test pieces of 3 mm in thickness and 5.5 cm in diameter are prepared by injection molding. The injection temperature is 220° C. and the mold temperature is 50° C. The test is carried out according to ASTM D-1003. The transparency is recorded as Haze(90°) and Haze(30°) which represent the viewing angles (between the viewing line and the horizontal surface of the sample) of 90 and 30 degree, respectively. The practical transparency (=Haze(30°)−Haze(90°)) is thus obtained. When the difference is smaller, the practical transparency is better.

2. Surface Roughness (ΔHmax, ΔHave) of the Molding of the Resin:

The resin is injection molded with a mirror mold (Akume No.2 standard of Akume Co.) to obtain test piece molding of 3 mm in thickness and 5.5 cm in diameter. The surface roughness of the mirror mold is about 0.1 μm according to JIS B0601, Ra method. The test piece is measured twenty times with the surface profiler (Tencor Alpha step 500) to obtain the maximum height difference (ΔHmax) and the average height difference (ΔHave).

3. Measurement of Impact Strength (Izod):

The Izod impact strength test is carried out according to ASTM D-256 (23-C, ¼″ inch in thickness with a notch).

4. The Weight Average Diameter of Dispersed Rubber Particle (A) and the Amount of Dispersed Rubber Particle (A) Having Diameter of Greater Than 0.78 μm of the Resin are Determined with a TEM by Ultrathin Section of Resin. It is Analyzed with a Photograph (12 cm×9.5 cm) of 25,000 Magnification. The Following Equation is Used to Evaluate the Weight Average Diameter of Dispersed Rubber Particle (A):

$$\begin{matrix}Weight average \\ diameter\end{matrix} = \frac{Σ ni {Di}^{4}}{Σ ni {Di}^{3}}$$

wherein ni is the number of rubber particles having diameter Di. In the photograph, the amount (wt %) of the dispersed rubber particle (A) having diameter greater than 0.78 μm is also determined, based on total the dispersed rubber particle (A), if the rubber particle is not in round shape, such as ellipse or stripe, the diameter of dispersed rubber particle (A) is determined as (major diameter+minor diameter)/2.

5. Content of Residual Volatile Components (Monomers and Solvents):

The resin (1 g) is dissolved in dimethyl formamide (DMF) (10 ml) and then analyzed with GC.

6. Ratio (A1/A2) of the Rubber Particles:

The test piece molding (without annealing) in accordance with Test 2 (Surface roughness) is cut into ultrathin section. The ultrathin section located at the depth of 1.8˜2.2 μm from the surface of the test piece molding is then observed in a TEM of 25,000 magnification and a photograph (12 cm×9.5 cm) is obtained. In the photograph, rubber particles having major diameter greater than 0.3 μm are selected for determination of the ratio (a/b) (major diameter (a) to minor diameter (b)). The average ratio (A1) is calculated according to the following equation:

$$A1 = \frac{n ( {a}_{i} ) /}{ Σ ( {b}_{i} ) / n}$$

wherein aᵢ is the major diameter and bᵢ is the minor diameter; n is the number of rubber particles having major diameter greater than 0.3 μm. In addition, the aforementioned test piece is further annealed at 120° C. for 40 min, and the average ratio of A2 of the annealed test piece is determined with the same procedure of determination of A1. Accordingly, a ratio (A1/A2) is obtained. In this specification, the major diameter is the length of a line (major axis) having the longest distance between two ends of a rubber particle, and the minor diameter is the length of a line (minor axis) perpendicular to the major axis and having the longest distance between two ends on the rubber particle along the minor axis. For an ideal elliptic rubber particle, the major and minor diameters thereof are just as those of the ellipse.

The above data regarding the rubber particle morphology are measured on an inner surface parallel to the top surface of the molding. By ultrathin section method, the test piece is cut into 0.05 μm-0.09 μm sections in thickness, wherein the section obtained at the depth of 1.8 μm˜2.2 μm is observed by TEM.

### EXAMPLES AND COMPARATIVE EXAMPLES

### Example 1

A feed solution containing 14.1 parts by weight of rubbery copolymer (styrene-butadiene block copolymer, styrene/butadiene=25/75 (wt %/wt %), 1,2-vinyl structure=15%, Moony viscosity=47 (ML₁₊₄, 100° C.)), 40 parts by weight of styrene, 57 parts by weight of methyl methacrylate, 3.0 parts by weight of acrylonitrile, 38 parts by weight of ethyl benzene, 0.15 part by weight of n-dodeyl mercaptan and a mixture including 0.018 part by weight of t-butyl cumyl peroxide (NIHON YUSI, Perbutyl C), 0.002 part by weight of m-toluoyl and benzoyl peroxide (NIHON YUSI, Nyper BMT-K40), and 0.095 part by weight of di-t-butyl peroxy hexahydro terephthalate is continuously fed into four CSTRs in series. Volume of each reactor is 40 liters. The feed solution is fed at a rate of 35 Kg/hr. The temperature of the four reactors is controlled at 100° C., 106° C., 120° C. and 130° C., and the agitation speed is 300 rpm, 200 rpm, 150 rpm and 90 rpm, respectively. Conversion of monomers at the outlet of the final reactor is 65%. The obtained resin solution is heated with a preheater at 250° C., and then passes through a devolatilizer with a vacuum unit at 240° C. to obtain resin pellets. The resin pellets are mixed with 0.02 wt. % of di-t-amyl peroxy through an extruder to obtain the transparent rubber-modified monovinylidene aromatic resin of the present invention.

The residual volatile content of the transparent rubber-modified monovinylidene aromatic resin is 0.12 wt. %. Physical properties of the resin, for example, transparency, practical transparency and impact strength, are listed in Table 1.

### Example 2

A feed solution containing 13.7 parts by weight of rubbery copolymers (styrene-butadiene block copolymer, styrene/butadiene=25/75(wt %/wt %), 1,2-vinyl structure=25%, Moony viscosity=49 (ML₁₊₄, 100° C.)), 37 parts by weight of styrene, 60 parts by weight of methyl methacrylate, 3.0 parts by weight of acrylonitrile, 38 parts by weight of ethyl benzene, 0.12 part by weight of n-dodeyl mercaptan and a mixture including 0.006 part by weight of t-butyl cumyl peroxide (NIHON YUSI, Per butyl C), 0.1 part by weight of m-toluoyl and benzoyl peroxide (NIHON YUSI, Nyper BMT-K40), and 0.02 part by weight of di-t-butyl peroxy hexahydro terephthalate is continuously fed into four CSTRs in series. Volume of each reactor is 40 liters. The feed solution is fed at a rate of 35 Kg/hr. The temperature of the four reactors is respectively controlled at 90° C., 100° C., 120° C. and 130° C., and the agitation speed is 250 rpm, 200 rpm, 150 rpm and 90 rpm, respectively. Conversion of monomers at the outlet of the final reactor is 66%. The obtained resin solution is heated with a preheater at 250° C., and then passes through a devolatilizer with a vacuum unit at 230° C. The resin are mixed with 0.03 wt. % of di-t-amyl peroxy through an extruder to obtain the transparent rubber-modified monovinylidene aromatic resin of the present invention.

The residual volatile content of the above resin is 0.142 wt. %. Physical properties of the resin, for example, transparency, practical transparency and impact strength , are listed in Table 1.

### Example 3

A feed solution containing 14.4 parts by weight of rubbery copolymers (composed of rubber (1), rubber (2) and rubber (3) in a ratio of (1)/(2)/(3)=95/312 by weight; wherein rubber (1) is styrene-butadiene block copolymer, and SM/BD=25/75(wt %/wt %), 1,2-vinyl structure =15%, Moony viscosity=47 (ML₁₊₄, 100° C.); rubber (2) is styrene-butadiene block copolymer, SM/BD=68/32(wt %/wt %), 1,2-vinyl structure =13%, solution viscosity=5.5 cps (5 wt. % of copolymer in toluene, 100° C.); rubber (3) is styrene-butadiene rubber, SM/BD=25/75(wt %/wt %), 1,2-vinyl structure=13%, solution viscosity=85 cps, Asahi Kasei, Tufdene 2330), 41 parts by weight of styrene, 55 parts by weight of methyl methacrylate, 4.0 parts by weight of acrylonitrile, 38 parts by weight of ethyl benzene, 0.12 part by weight of n-dodeyl mercaptan, and 0.09 part by weight of m-toluoyl and benzoyl peroxide (NIHON YUSI, Nyper BMT-K40), and 0.02 part by weight of di-t-butyl peroxy hexahydro terephthalate is continuously fed into four CSTRs in series. Volume of each reactor is 40 liters. The feed solution is fed at a rate of 35 kg/hr. The temperature of the four reactors is respectively controlled at 90° C., 100° C., 120° C. and 127° C., and the agitation speed is 300 rpm, 200 rpm, 150 rpm and 120 rpm, respectively. Conversion of monomers at the outlet of the final reactor is 68%. The obtained polymeric solution is preheated with a preheater at 260° C., and then passes through a devolatilizer with a vacuum unit at 250° C. to obtain resin pellets. The resin pellets are mixed with 0.015 wt. % of di-t-amyl peroxy through an extruder to obtain the transparent rubber-modified monovinylidene aromatic resin of the present invention.

The residual volatile content of the above resin is 0.16 wt. %. Physical properties of the resin, for example, transparency, practical transparency and impact strength, are listed in Table 1.

### Example 4

A feed solution containing 19.3 parts by weight of rubbery copolymers (composed of rubber (1) and rubber (2) in a ratio of (1)/(2)=93/7 (wt %/wt %) ; wherein rubber (1) is styrene-butadiene block copolymer, SM/BD=25/75(wt %/wt %), 1,2-vinyl structure=15%, Moony viscosity=47 (ML₁₊₄, 100° C.); rubber (2) is styrene-butadiene rubber, SM/BD=25/75(wt %/wt %), 1,2-vinyl structure=30%, Moony viscosity=55 (ML₁₊₄, 100° C.), Asahi Kasei, Tufdene 2330), 38 parts by weight of styrene, 58 parts by weight of methyl methacrylate, 4.0 parts by weight of acrylonitrile, 80 parts by weight of ethyl benzene, 0.14 part by weight of n-dodeyl mercaptan, and 0.009 part by weight of α,α′-bis-(t-butyl peroxy)diisopropyl benzene (NIHON YUSI, Per butyl P), 0.135 part by weight of m-toluoyl and benzoyl peroxide (NIHON YUSI, Nyper BMT-K40), and 0.005 part by weight of di-t-butyl peroxy hexahydro terephthalate is continuously fed into three CSTRs and one PFR (the fourth reactor) in series. Volume of each reactor is 40 liters. The feed solution is fed at a rate of 35 kg/hr. The temperature of the four reactors is respectively controlled at 90° C., 100° C., 125° C. and 128° C. (inlet)-155° C. (outlet), and the agitation speed is 300 rpm, 200 rpm, 150 rpm and 30 rpm, respectively. Conversion of monomers at the outlet of the final reactor is 90%. The obtained polymeric solution is heated with a preheater at 230° C., and then passes through a devolatilizer with a vacuum unit at 230° C. to obtain resin pellets. The resin pellets are mixed through a twin-screw extruder (with vent) at 250° C. to obtain the transparent rubber-modified monovinylidene aromatic resin of the present invention is obtained.

The residual volatile content of the above resin is 0.22 wt. %. Physical properties of the resin, for example, transparency, practical transparency and impact strength , are listed in Table 1.

### Example 5

A feed solution containing 18.1 parts by weight of rubbery copolymers (composed of rubber (1) and rubber (2) in a ratio of (1)/(2)=93/7 (wt %/wt %) ; wherein rubber (1) is styrene-butadiene block copolymer, SM/BD=25/75(wt %/wt %), 1,2-vinyl structure =15%, Moony viscosity=47 (ML₁₊₄, 100° C.); rubber (2) is styrene-butadiene rubber, SM/BD=25/75(wt %/wt %), 1,2-vinyl structure =30%, Moony viscosity=55 (ML₁₊₄, 100° C.), Asahi Kasei, Tufdene 2330), 36 parts by weight of styrene , 61 parts by weight of methyl methacrylate, 3.0 parts by weight of acrylonitrile, 63.6 parts by weight of ethyl benzene, 0.16 part by weight of n-dodeyl mercaptan, and 0.005 part by weight of α,α′-bis-(t-butyl peroxy)diisopropyl benzene (NIHON YUSI, Per butyl P), 0.002 part by weight of m-toluoyl and benzoyl peroxide (NIHON YUSI, Nyper BMT-K40), and 0.13 part by weight of di-t-butyl peroxy hexahydro terephthalate is continuously fed into three CSTRs and one PFR(the fourth reactor) in series. Volume of each reactor is 40 liters. The feed solution is fed at a rate of 35 kg/hr. The temperature of the four reactors respectively is controlled at 98° C., 105° C., 126° C. and 128° C. (inlet)-150° C. (outlet), and the agitation speed is 310 rpm, 210 rpm, 150 rpm and 30 rpm, respectively. Conversion of monomers at the outlet of the final reactor is 85%. The obtained polymeric solution is heated with a preheater at 260° C., and then passes through a devolatilizer with a vacuum unit at 240° C. to obtain resin pellets. The resin pellets are mixed with 1 wt. % of water (an stripping agent) through a twin-screw extruder (with vents) at 225° C. Eventually, the transparent rubber-modified monovinylidene aromatic resin of the present invention is obtained.

The residual volatile content of the above resin is 0.14 wt. %. Physical properties of the resin, for example, transparency, practical transparency and impact strength, are listed in Table 1.

### Example 6

A feed solution containing 18.3 parts by weight of rubbery copolymers (composed of rubber (1) and rubber (2) in a ratio of (1)/(2)=93/7(wt %/wt %); wherein rubber (1) is styrene-butadiene block copolymer, SM/BD=25/75(wt %/wt %), 1,2-vinyl structure =15%, Moony viscosity=47 (ML₁₊₄, 100° C.); rubber (2) is styrene-butadiene rubber, SM/BD=25/75(wt %/wt %), 1,2-vinyl structure =30%, Moony viscosity=55 (ML₁₊₄, 100° C.), Asahi Kasei, Tufdene 2330), 39 parts by weight of styrene , 58 parts by weight of methyl methacrylate, 3 parts by weight of acrylonitrile, 50.7 parts by weight of ethyl benzene, 0.15 part by weight of n-dodeyl mercaptan, and 0.025 part by weight of α,α′-bis-(t-butyl peroxy)diisopropyl benzene (NIHON YUSI, Per butyl P), 0.002 part by weight of m-toluoyl and benzoyl peroxide (NIHON YUSI, Nyper BMT-K40), and 0.1 part by weight of di-t-butyl peroxy hexahydro terephthalate is continuously fed into three CSTRs and one PFR(the fourth reactor) in series. Volume of each reactor is 40 liters. The feed solution is fed at a rate of 35 kg/hr. The temperature of the four reactors is respectively controlled at 100° C., 106° C., 124° C. and 126° C. (inlet)-151° C. (outlet), and the agitation speed is 300 rpm, 200 rpm, 150 rpm and 30 rpm, respectively. Conversion of monomers at the outlet of the reactor is 85%. The obtained polymeric solution is heated with a preheater at 220° C., and then passes through a devolatilizer with a vacuum unit at 240° C. to obtain resin pellets. The resin pellets are mixed with 0.5 wt. % of water through a twin-screw extruder (with vents) at 230° C. Eventually, the transparent rubber-modified monovinylidene aromatic resin of the present invention is obtained. The residual volatile content of the above resin is 0.15 wt. %. Physical properties of the resin, for example, transparency, practical transparency and impact strength, are listed in Table 1.

### Example 7

100 parts by weight of the transparent rubber-modified monovinylidene aromatic resin obtained in Example 1 and 8 parts by weight of methyl methacrylate-butadiene-styrene graft copolymers (produced by emulsion polymerization, Taiwan Kureha Co., KCB650L) are blended and extruded to obtain transparent rubber-modified monovinylidene aromatic resin. The residual volatile content of the above resin is 0.1 wt. %. Physical properties of the resin, for example, transparency, practical transparency and impact strength, are listed in Table 1.

### Example 8

A feed solution containing 18.3 parts by weight of rubbery copolymers (composed of rubber (1) and rubber (2) in a ratio of (1)/(2)=93/7(wt %/wt %); wherein rubber (1) is styrene-butadiene block copolymer, SM/BD=25/75(wt %/wt %), 1,2-vinyl structure=15%, Moony viscosity=47 (ML₁₊₄, 100° C.); rubber (2) is styrene-butadiene rubber, SM/BD=25/75(wt %/wt %), 1,2-vinyl structure=30%, Moony viscosity=55 (ML₁₊₄, 100° C.), Asahi Kasei, Tufdene 2330), 40.5 parts by weight of styrene, 58 parts by weight of methyl methacrylate, 1.5 parts by weight of n-butyl acrylate, 50.7 parts by weight of ethyl benzene, 0.15 part by weight of n-dodeyl mercaptan, and 0.025 part by weight of α,α′-bis-(t-butyl peroxy)diisopropyl benzene (NIHON YUSI, Per butyl P), 0.002 part by weight of m-toluoyl and benzoyl peroxide (NIHON YUSI, Nyper BMT-K40), and 0.1 part by weight of di-t-butyl peroxy hexahydro terephthalate is continuously fed into three CSTRs and one PFR (the fourth reactor) in series. Volume of each reactor is 40 liters. The feed solution is fed at a rate of 35 Kg/hr. The temperature of the four reactors is respectively controlled at 100° C., 106° C., 125° C. and 127° C. (inlet)-151° C. (outlet) and the agitation speed is 300 rpm, 200 rpm, 150 rpm and 30 rpm, respectively. Conversion of monomers at the outlet of the final reactor is 86%. The obtained polymeric solution is heated with a preheater at 240° C., and then passes through a devolatilizer with a vacuum unit at 220° C. to obtain resin pellets. The resin pellets are mixed with 0.5 wt. % of water through a twin-screw extruder (with vents) at 235° C. to obtain transparent rubber-modified monovinylidene aromatic resin.

The residual volatile content of the above resin is 0.152 wt. %. Physical properties of the resin, for example, transparency, practical transparency and impact strength, are listed in Table 1.

### Comparative Example 1

A feed solution containing 13 parts by weight of rubbery copolymers (styrene-butadiene block copolymer, SM/BD=25/75(wt %/wt %), 1,2-vinyl structure=15%, Moony viscosity=47 (ML₁₊₄, 100° C.)), 38 parts by weight of styrene, 58 parts by weight of methyl methacrylate, 4 parts by weight of acrylonitrile, 37.7 parts by weight of ethyl benzene, and 0.1 part by weight of di-t-butyl peroxy hexahydro terephthalate is continuously fed into three serial CSTRs in series. Volume of each reactor is 40 liters. The feed solution is fed at a rate of 35 Kg/hr. The temperature of the three reactors is respectively controlled at 95° C., 105° C. and 125° C., and the agitation speed is 300 rpm, 200 rpm and 150 rpm, respectively. Conversion of monomers at the outlet of the final reactor is 62%. The obtained polymeric solution is heated with a preheater at 240° C., and then passes through a devolatilizer with a vacuum unit at 220° C. to obtain the rubber-modified monovinylidene aromatic resin.

The residual volatile content of the rubber-modified monovinylidene aromatic resin is 0.38 wt. %. Physical properties of the resin, for example, transparency, practical transparency and impact strength, are listed in Table 1.

### Comparative Example 2

A feed solution containing 14.3 parts by weight of rubbery copolymers (styrene-butadiene block copolymer, SM/BD=25/75(wt %/wt %), 1,2-vinyl structure=15%, Moony viscosity=47 (ML₁₊₄, 100° C.)), 38 parts by weight of styrene , 60 parts by weight of methyl methacrylate, 2 parts by weight of acrylonitrile, 38.1 parts by weight of ethyl benzene, 0.15 part by weight of n-dodeyl mercaptan, and 0.115 part by weight of di-t-butyl peroxy hexahydro terephthalate is continuously fed into four CSTRs in series. Volume of each reactor is 40 liters. The feed solution is fed at a rate of 35 Kg/hr. The temperature of the four reactors is respectively controlled at 100° C., 106° C., 124° C. and 134° C., and the agitation speed is 300 rpm, 200 rpm, 150 rpm and 120 rpm, respectively. Conversion of monomers at the outlet of the final reactor is 66%. The obtained polymeric solution is heated with a preheater at 230° C., and then passes through a devolatilizer with a vacuum unit at 220° C. to obtain resin pellets. The resin pellets then mixed with 1 wt. % of water through a twin-screw extruder (with vents) at 225° C. to obtain the rubber-modified monovinylidene aromatic resin.

The residual volatile content of the rubber-modified monovinylidene aromatic resin is 0.15 wt. %. Physical properties of the resin, for example, transparency, practical transparency and impact strength, are listed in Table 1.

### Comparative Example 3

A feed solution containing 17.8 parts by weight of rubbery copolymers (composed of rubber (1) and rubber (2) in a ratio of (1)/(2)=90/10 (wt %/wt %); wherein rubber (1) is styrene-butadiene block copolymer, SM/BD=25/75(wt %/wt %), 1,2-vinyl structure=15%, Moony viscosity=47 (ML₁₊₄, 100° C.); rubber (2) is butadiene rubber, 1,2-vinyl structure=11%, Moony viscosity=47 (ML₁₊₄, 100° C.), cis-structure=35%, Chi Mei Co. PR-255), 36 parts by weight of styrene , 61 parts by weight of methyl methacrylate, 3 parts by weight of acrylonitrile, 39.3 parts by weight of ethyl benzene, 0.12 part by weight of n-dodeyl mercaptan, and 0.005 part by weight of t-butyl cumyl peroxide (NIHON YUSI, Per butyl C), and 0.08 part by weight of m-toluoyl and benzoyl peroxide (NIHON YUSI, Nyper BMT-K40) is continuously fed into three CSTRs and one PFR (the fourth reactor) in series. Volume of each reactor is 40 liters. The feed solution is fed at a rate of 35 Kg/hr. The temperature of the four reactors is respectively controlled at 90° C., 105° C., 124° C. and 126° C.(inlet)-150° C.(outlet), and the agitation speed is 300 rpm, 200 rpm, 100 rpm and 30 rpm, respectively. Conversion of monomers at the outlet of the final reactor is 84%. The polymeric solution is heated with a preheater at 260° C., and then passes through a devolatilizer with a vacuum unit at 255° C. to obtain the rubber-modified monovinylidene aromatic resin.

The residual volatile content of the rubber-modified monovinylidene aromatic resin is 0.24 wt. %. Physical properties of the resin, for example, transparency, practical transparency and impact strength, are listed in Table 1.

### Comparative Example 4

A feed solution containing 11.7 parts by weight of rubbery copolymers (composed of rubber (1), rubber (2) and rubber (3) in a ratio of (1)/(2)/(3)=60/35/5 by weight; wherein rubber (1) is styrene-butadiene block copolymer, SM/BD=25/75(wt %/wt %), 1,2-vinyl structure=15%, Moony viscosity=47 (ML₁₊₄, 100° C.); rubber (2) is butadiene rubber, Moony viscosity=47 (ML₁₊₄, 100° C.), 1,2-vinyl structure=11%, Chi Mei Co. PR-255; rubber (3) is styrene-butadiene copolymers, SM/BD=68/32(wt %/wt %), 1,2-vinyl structure=13%, solution viscosity=5.5 cps (25° C., 5 wt. % of copolymers in toluene)), 41 parts by weight of styrene , 55 parts by weight of methyl methacrylate, 4.0 parts by weight of acrylonitrile, 37.2 parts by weight of ethyl benzene, 0.15 part by weight of n-dodeyl mercaptan, 0.005 part by weight of benzoyl peroxide, and 0.095 part by weight of di-t-butyl peroxy hexahydro terephthalate is continuously fed into four CSTRs in series. Volume of each reactor is 40 liters. The feed solution is fed at a rate of 35 Kg/hr. The temperature of the four reactors is respectively controlled at 95° C., 100° C., 124° C. and 132° C., and the agitation speed is 200 rpm, 150 rpm, 100 rpm and 90 rpm, respectively. Conversion of monomers at the outlet of the final reactor is 55%. The obtained polymeric solution is preheated with a pre-heater at 225° C., and then passes through the devolatilizer with a vacuum unit at 210° C. to obtain the rubber-modified monovinylidene aromatic resin.

The residual volatile content of the rubber-modified monovinylidene aromatic resin is 0.45 wt. %. Physical properties of the resin, for example, transparency, practical transparency and impact strength, are listed in Table 1.

### Comparative Example 5

A feed solution containing 12.4 parts by weight of rubbery copolymers (styrene-butadiene block copolymer, SB/BD=68/32(wt %/wt %), 1,2-vinyl structure=13%, solution viscosity=5.5 cps (5 wt. % of copolymer in toluene)), 37 parts by weight of styrene , 60 parts by weight of methyl methacrylate, 3 parts by weight of acrylonitrile, 56.2 parts by weight of ethyl benzene, 0.16 part by weight of n-dodeyl mercaptan, and 0.115 part by weight of di-t-butyl peroxy hexahydro terephthalate is continuously fed into four CSTRs in series. Volume of each reactor is 40 liters. The feed solution is fed at a rate of 35 Kg/hr. The temperature of the four reactors is respectively controlled at 100° C., 106° C., 120° C. and 130° C., and the agitation speed is 300 rpm, 250 rpm, 150 rpm and 120 rpm, respectively. Conversion of monomers at the outlet of the final reactor is 65%. The obtain polymeric solution is heated with a preheater at 255° C., and then passes through the devolatilizer with a vacuum unit at 250° C. to obtain the rubber-modified monovinylidene aromatic resin.

The residual volatile content of the rubber-modified monovinylidene aromatic resin is 0.3 wt. %. Physical properties of the resin, for example, transparency, practical transparency and impact strength, are listed in Table 1.

### Comparative Example 6

A feed solution containing 14.1 parts by weight of rubbery copolymers (styrene-butadiene block copolymer, SB/BD=25/75(wt %/wt %), 1,2-vinyl structure=15%), 40 parts by weight of styrene, 57 parts by weight of methyl methacrylate, 3 parts by weight of acrylonitrile, 38 parts by weight of ethyl benzene, 0.15 part by weight of n-dodeyl mercaptan, 0.08 part by weight of benzoyl peroxide, and 0.155 part by weight of di-t-butyl peroxy hexahydro terephthalate is continuously fed into three CSTRs and one PFR(the fourth reactor) in series. Volume of each reactor is 40 liters. The feed solution is fed at a rate of 35 Kg/hr. The temperature of the four reactors is respectively controlled at 102° C., 108° C., 126° C. and 128° C.(inlet)-153° C.(outlet), and the agitation speed is 300 rpm, 200 rpm, 150 rpm and 30 rpm, respectively. Conversion of monomers at the outlet of the final reactor is 88%. The obtained polymeric solution is heated with a preheater at 260° C., and then passes through the devolatilizer with a vacuum unit at 260° C. to obtain rubber-modified monovinylidene aromatic resin.

The residual volatile content of the rubber-modified monovinylidene aromatic resin is 0.22 wt. %. Physical properties of the resin, for example, transparency, practical transparency and impact strength, are listed in Table 1.

The preceding description is set forth for purposes of illustration only and is not to be taken in a limited sense. Various modifications and alterations will be readily suggested to person skilled in the art. It is intended, therefore, that the foregoing be considered as exemplary only and that the scope of the invention be ascertained from the following

What is claimed is:

1. A transparent rubber-modified monovinylidene aromatic resin, comprises (i) 1-25 wt. % of dispersed rubber particle (A) comprising rubbery copolymer (ii) 99-75 wt. % of continuous phase matrix copolymer (B); wherein said copolymer (B) is prepared from monomers comprising 20-70 parts by weight of monovinylidene aromatic monomers, 30-80 parts by weight of ester of (meth)acrylic acid monomers and 0-40 parts by weight of copolymerizable monomers; and
wherein the maximum height difference (ΔHmax) of the surface of the molding of said transparent rubber-modified monovinylidene aromatic resin is less than 3,200 Å and the average height difference (ΔHave) is less than 2,000 Å; wherein said molding is produced by injection with a mirror mold;
wherein the ratio of A1/A2 of the rubber particles of dispersed rubber particle (A) having a major diameter of greater than 0.3 μm and located at a depth of 1.8 μm-2.2 μm from a surface of said molding is in the range of 1.08˜2.35; wherein A1 and A2 represent the average ratio of major diameter to minor diameter of said rubber particles before and after annealing at 120° C. for 40 mins of said molding, respectively.

2. The transparent rubber-modified monovinylidene aromatic resin according to claim 1, wherein said dispersed rubber particle (A) having diameter greater than 0.78 μm is in an amount of 0-25 wt. %, based on total dispersed rubber particle (A).

3. The transparent rubber-modified monovinylidene aromatic resin according to claim 1, wherein the weight average diameter of said dispersed rubber particle (A) is in the range of 0.18 μm˜1.0 μm.

4. The transparent rubber-modified monovinylidene aromatic resin according to claim 1, wherein the ratio of (A1/A2) of said rubber particles is in the range of 1.08˜2.2.

5. The transparent rubber-modified monovinylidene aromatic resin according to claim 1, wherein the ratio of (A1/A2) of said rubber particles is in the range of 1.10 to 2.0.
